(19) United States
(12) Patent Application Publication
(10) Pub. No.: US 2023/0051584 A1
(43) Pub. Date: Feb. 16, 2023

(54) HEAT ACTIVATED ADHESIVE TAPES FOR JOINING FABRIC SEGMENTS

(71) Applicant: DAVIK INDUSTRIES ACS LTD, Kibbutz Sde-Boker (IL)

(72) Inventors: Inbal Kamri, Dimona (IL); Afik Orr, Beer Sheva (IL); Nitsa Mazor, Kibbutz Sde Boker (IL); Guy Wind, Kibbutz Sde Boker (IL)

(73) Assignee: DAVIK INDUSTRIES ACS LTD, Kibbutz Sde-Boker (IL)

(21) Appl. No.: 17/793,905

(22) PCT Filed: Jan. 28, 2020
(86) PCT No.: PCT/IL2021/050079

§ 371 Date: Jul. 19, 2022

(30) Foreign Application Priority Data
Jan. 28, 2020 (IL) 272311

(51) Int. Cl. C09J 7/35

(52) U.S. Cl. CPC C09J 7/35; C09J 2479/08; C09J 2475/00

(57) ABSTRACT

The application discloses a tape for stitchless joining of fabric sections. In some embodiments the tape is heat activated and includes a thermostable liner and a layer of dry latex of polyurethane with a crosslinker. Methods of manufacturing and using the tape are also disclosed.

### FIELD OF THE INVENTION

The present invention relates to a tape for stitchless joining fabric sections. Particularly, the invention relates to a tape comprising a heat activated adhesive layer releasable from a liner to fabric substrates and creating stable attachment between fabric segments. More particularly, the invention relates to manufacturing stable rolls of polyurethane based films for joining fabric segments in clothes manufacture.

### BACKGROUND OF THE INVENTION

Combining pieces of materials to greater ones by sewing, to make clothes or tents to protect people from surrounding, belongs among most ancient human activities going back to Paleolithic era. Some believe that inability of Neanderthals to create clothes, in contrast to Humans, led to their extinction. Sewing was firstly used for stitching together animal hides, for example using thread made of animal sinew and needles made of bone, and later for joining pieces of woven fabrics. For thousands years, cloth was cut to predetermined pieces to be reassembled to three dimensional structures with thread manually passed through the cloth by a needle, painfully stitch by stitch. Only 200 years ago, a sewing machine was invented to lead the thread through the fabric pieces, but principle of perforating the fabric with a thread remained the same, and the sewing machine had to be still guided by human hand. Nowadays seamstresses are still sewing by stitching together segments created according to a planned pattern, the row of stitches forming the seam.

Only recently a seamless technique of clothe making was introduced, employing thermoplastic polymers for bonding textile pieces together without using thread and needle. This technique brings still nearer the dream of entire digitalization of clothes production, from an endless fabric roll, via software-guided pattern creation and machine-cut segments, to automatically bonding the segment to the final clothes.

A number of techniques have been described for applying various polymer mixtures onto the textile pieces to be connected. One of the problems lies in providing a polymeric mixture which can be easily transferred onto the fabric, while ensuring that the bonding reaction does not damage the fabric, wherein the reaction conditions enable good synchronization between the step of placing the bonded pieces together and the step of initiating the reaction resulting in a strong textile glue. Other problems associated with various techniques include among others and beside cost-effectiveness, storage stability of the pre-prepared bonding means, toxicity of the reagents, incorporation of organic volatiles into the fabric, deteriorated appearance of the bonded parts which should be free of warping and yellowing, and stability which should endure repeated washing. It is therefore an object of the invention to provide a practical and upscalable means for stitchless joining fabric pieces at temperatures not damaging usual textiles

It is another object of this invention to provide a heat activated adhesive tape for joining fabric segments at temperatures of less than 200° C.

It is a further object of this invention to provide a cost effective system for joining two fabric sections in a stitchless way.

It is still another object of this invention to provide a method of manufacturing a heat activated adhesive tape for stitchless joining fabric sections by employing commercially available polymer raw materials.

Other objects and advantages of present invention will appear as the description proceeds.

### SUMMARY OF THE INVENTION

This invention provides a heat activated adhesive tape for stitchless joining fabric sections, the tape comprising a thermostable liner coated with dry latex of polyurethane with a crosslinker. Said latex consists of 95-99.9% aliphatic polyurethanes, 0.05-1% crosslinker, up to 3% water, and up to 5% additives. The unit “%” means weight percent of the whole. Said polyurethanes comprise polyether polyurethanes and polyester polyurethanes. Said crosslinker may also comprise additional agents, including polyfunctional crosslinkers such as polyisocyanate derivatives. Said liner is a film comprising a fiber web or a polymer mat, comprising for example woven or nonwoven fabric or a thin layer of material comprising at least one polymer, synthetic or natural, including cellulose, wherein the liner is stable at temperatures of up to 200° C. for a time of at least 60 s; the material may comprise paper. Said latex coating said liner constitutes a layer having a thickness of from 5 to 500 μm, preferably from 10 to 250 μm, such as from 20 to 125 μm.

The term “latex” is usually employed for denoting a suspension of fine polymer particles in aqueous liquid, wherein the particles size distribution enables relatively high phase stability of the system. In the context of this invention, the term is used for suspensions comprising polymers together with additional agents needed for the desired activity of the product. A latex in the context of the invention comprises fine particles of one or more polymers, one or more crosslinkers, optionally further additives, and water in a desired amount. The amount of water in the raw latex before its layering onto the liner affects the liquid behavior, and it conditions the method which may be optionally employed for spreading the latex onto the surface of the liner, which may include pouring and spraying, or other method known in the art, selected by a skilled person. Gradually removing water from the raw latex will result in formation of slurry, paste, and particle layer of decreasing humidity. In view of the continual character of the phase transition in the system during water removal, the mixture can be seen as a latex exhibiting more or less moisture. In other words, the raw latex results in a dry latex during the step of heating in a drying oven. The temperature in the oven is not high enough to melt the polymer or to substantially activate the crosslinker, which processes are initiated only at higher temperatures when the dry latex acts as a bonding agent. The crosslinking reactions in the polymers require increasing the temperature and water stability of the adhesive.

The latex in the tape of the invention is released from said liner to a first fabric section when the section is pressed against the latex at a releasing temperature of 110° C. or more. Usually, said releasing temperature is between 120 and 150° C., such as between 130 and 140° C. Said latex bonds said first fabric section to a second fabric section when said first section is pressed against said second section at a bonding temperature of 165° C. or more, usually a temperature between 160 and 190° C., such as 170 and 180° C., is employed.

The invention relates to a method of manufacturing a heat activated adhesive tape as described above for stitchless joining fabric sections, the method comprising steps of i) providing an aqueous dispersion of aliphatic polyurethanes, and a crosslinker; ii) homogenizing said polyurethanes and said crosslinker at ambient temperature, and optionally admixing additives, thereby obtaining a raw liquid latex; iv) layering said raw liquid latex onto the surface of a thermostable liner; v) drying said liner with said raw latex in a high-efficient drying tunnel at a temperature lower than 100° C., thereby obtaining a liner film coated with a layer of dry latex; vi) cooling said film; and vii) cutting the film to obtain bands of a desired width and length, and folding the bands to obtain rolls of said tape, or folding the film of a desired length to a film roll and cutting the film roll at a desired width to obtain rolls of said tape; thereby obtaining rolls of said heat activated adhesive tape for stitchless joining fabric sections, stable at storage and ready for future use. Said dispersion of aliphatic polyurethanes usually comprises 30-65% polyether polyurethanes in water. Said crosslinker is usually added in an aqueous mixture. Said additives may be selected from dispersants, surfactants, antifoams, fillers, stabilizers, preservatives, flexibility enhancers, plasticizers, and dyes. Said layer of the dry latex has preferably a thickness of from 10 to 200 μm, such as from 20 to 100 μm, for example from 25 to 75 μm. Said polyurethanes, crosslinkers and additives are added in said raw liquid latex in amounts providing a dry latex composition containing 95-99.9% water-based aliphatic polyurethanes, 0.05-1% crosslinker, and up to 5% additives, for example 97-99.5% aliphatic polyurethanes, 0.05-0.5%, and up to 1.5% additives.

The invention provides a method of joining two fabric sections in a stitchless way, comprising steps of i) placing a heat activated adhesive tape as defined above on a first fabric section with the latex facing the fabric and the liner upside, and pressing the tape against said fabric at a releasing temperature of 110° C. or more, such as for example 120° C. or 130° C. or 140° C., at a pressure of 2 bars or more, such as for example 4 bars or 6 bars, for a time of 2 s or more, such as 4 s or 6 s or 10 s, thereby releasing said latex onto the surface of said first fabric section and defining a bonding area; ii) removing the liner from said bonding area; iii) placing a second fabric section on said first fabric section at said bonding area and pressing the two fabric sections to each other at said bonding area at a bonding temperature of 160° C. or more, such as 170° C. or 180° C., at a pressure of 2 bars or more, such as for example 4 bars or 6 bars, for a time of 5 s or more, such as 10 s or 20 s or 30 s or more; thereby bonding said two fabric sections in a stitchless way at said bonding area, wherein said bonding is stable during repeated cycles of laundry, for example 25 washing cycles or more, for example 100 cycles at a temperature of 60° C. and rotation velocity of 1000 rpm. The bonding tape of the invention does not increase volatile organic compound content in the bonded fabrics. The bond shows great adhesive strength and great stability to hydrolysis.

The invention provides a fabric article comprising at least two fabric segments joined by a heat activated cross-linked layer of dry latex of polyurethane. Particularly, said article comprises a garment.

### DETAILED DESCRIPTION OF THE INVENTION

It has now been found that a latex mixture comprising a water suspension of 35-50% aliphatic polyurethanes and about 0.1% crosslinker can be coated onto paper liners and dried at a drying tunnel at a temperature below 100° C. to provide a tape with a dry-latex layer of 25-50 micron in thickness, comprising about 90-99% thermoplastic polymers, wherein the layer can be easily transferred onto a first polyester woven fabric segment at 135° C. under a pressure of 5 bars within in 5 s, wherein another segment can be bonded to the first segment at a temperature of 175° C. under a pressure of 5 bars within in 20 s, providing a connection stable under the conditions of at least 25 laundry cycles.

The heat activated adhesive tape of the invention for sewless connecting fabric segments is preferably rolled up and ready for use in clothes manufacture. The tape comprises a thermostable liner made of any material not reacting with the polyurethane based latex and crosslinkers at ambient temperatures and easily releasing the latex in contact with textile under working conditions; the liner may comprise, for example, silicon-coated paper or silicon coated PRET film. The tape comprises a layer of dry latex of polyurethane with a crosslinker detachable under working conditions, stable and not yellowing under storage conditions, namely at ambient temperatures and at dry place. Under working conditions, comprising releasing conditions and bonding conditions, the latex is released from the liner and activated. The dry latex is released from the liner into a first fabric segment under releasing conditions, namely temperatures higher than 110° C. and pressures at least 2 bars, and it is activated when a second segment is in contact with the first segment at a temperature of at least 160° C. and pressures at least 2 bars, the molten latex penetrates both fabric segments and the crosslinkers immobilize the polymer within the fabric structure.

Said dry latex contains 90-99.9% aliphatic polyurethanes, such as 93-99.8%, for example 95-99.5%. The polyurethanes preferably comprise aliphatic polyether polyurethanes and aliphatic polyester polyurethanes, for example in a weight ratio of the former to the latter of from 5:1 to 20:1, such as about 10:1. The dry latex contains crosslinkers, usually at a concentration of 0.05-2%, such as 0.1-1%, and up to 5% additives which either auxiliary materials present in the employed raw materials or which improve the properties of the latex or the bonding layer, the additives constituting for example about 5% of the dry latex, such as about 4% or less, or about 3% or less, or about 2% or less, or up to 1%; the properties may include stability or activity of the latex or its reaction products. The dry latex may comprise up to 3% water, preferably up to 2%, such as up to 1%, for example 0.2%. The raw materials for preparing said dry latex usually comprise liquid latex mixtures comprising 30-70% water, and the preparation of the dry latex layer on the liner includes the step of water removal, resulting in the formation of a layer of polymer particles with small amounts or residual water; the optimal bonding conditions require reducing the water concentration below 3%.

Said crosslinker may comprise polyisocyanates, polycarbodiimides, melamine formaldehydes, epoxies, and aziridines. Examples of polyisocyanates include Basonat F 200, Basonat LR 9056 (BASF), ACCUADUR 9100 (Synthecoat S.L.U), HYCRYL® 0905 (Arkema); examples of polycarbodiimides include CARBODILITE E-02 (Nisshinbo chemical Inc.), Picassian XL-732 (Picassian polymers), ZOLDINE XL-29SE (Angus chemical company); examples of melamine formaldehydes include hexamethoxymethyl melamine related compounds like ((4,6-Bis(bis(methoxymethyl)amino)-1,3,5-triazin-2-yl)(methoxymethyl)amino)methanol, N2-(Methoxymethyl)-N2,N4,N4,N6,N6-pentame thyl-1,3,5-triazine-2,4,6-triamine, CYMEL 300 (Allnex), partially methylated melamine formaldehyde like CYMEL 370 (Allnex), high imino resins like CYMEL 323 (Allnex), highly alkylated melamine resins like CYMEL 1116 (Allnex), high imino melamine resins like CYMEL 202 (Allnex); epoxies may include ERISYS® GE-61(CVC Thermoset Specialties), Coatosil MP 200, Coatosil1770 (Momentive), Bisphenol A diglycidyl ether (Sigma); examples of azeridines include CX-100 (DSM), PZP-1000, PZBI-25 (polyazeridine global, S.L), or Picassian® XL-706 (Picassian polymers).

The method of manufacturing a heat activated adhesive tape for stitchless joining fabric segments comprises mixing aqueous dispersions of aliphatic polyurethanes with crosslinkers, and optionally with additives, under conditions providing stability to the components, usually at ambient temperatures, thereby obtaining a raw liquid latex, layering said raw liquid latex onto the surface of a thermostable liner, and drying said liner with said raw latex in a high-efficient drying tunnel at a temperature lower than 100° C., such as 90° C. or less, for example 70-90° C. Said additives may comprise dispersants, wetting agents, thickeners, tackifiers, adhesion promoters, antifoams, fillers, stabilizers, preservatives, flexibility enhancers, plasticizers, and dyes. The coated liner is cut and rolled or rolled and cut, to obtain the band of a desired width and length in rolls of the according to the invention, stable at ambient temperature and ready for joining any segments of materials used in the clothes industry.

The system and the method of joining two fabric sections in a stitchless way according to the invention comprises providing a raw liquid latex containing aqueous dispersion of aliphatic polymers and oligomers and multifunctional water-soluble crosslinkers, mainly polyurethanes and a crosslinker, layering said liquid latex on a thermostable liner to obtain the liner coated with a dry latex serving as an efficient heat activated adhesive tape for sewless combining fabric segments under working conditions comprising releasing conditions and bonding conditions, the former including temperatures of 110-150° C. and the latter including temperatures of 160-190° C., both including pressures of 1-10 bars over a time period of between 2-30 s. Said liner may comprise MGK (machine-glazed kraft papers), glassine paper, SCK (supercalendered kraft paper), CCK (clay coated kraft paper), or PET; the liner exhibiting, for example 80 to 120 gram per square meter, or a thickness of up to 100 micron, for example 36-75 micron.

The invention relates to a system and a method providing a fabric article comprising two fabric segments joined by a heat activated, cross-linked, layer of dry latex of polyurethane. Said dry latex is transferred onto the segments from a tape comprising a thermostable liner and said dry latex, comprising polyurethane and crosslinker; said latex usually consisting of 95-99.9% aliphatic polyurethanes, 0.05-1% crosslinker, and up to 5% additives; said polyurethanes usually comprising polyether polyurethanes and polyester polyurethanes; said crosslinker usually comprising polyisocyanates, polycarbodiimides, melamine formaldehydes, epoxies, or aziridines. The invention provides a fabric article comprising at least two fabric segments joined by a heat activated, cross-linked, layer of dry latex of polyurethane. Particularly, said article comprises a garment.

The system of the invention is advantageously employed for producing garments, shirts, underwear, brassieres, panties, lingerie, shorts, swimwear, hosiery, sleepwear, dresses, blouses, aprons, hats, belts, suits, uniforms, rainwear, pants, sweaters, jackets, vests, knickers, socks, diving suits, protective clothing, tights, towel, medical cloth, and bandage. The tape of the invention can be employed for joining segments of all materials used in the clothes industry, including nylon, polyester, cellulose-based fibers including cotton, but also other materials, like leather. The bonding areas or connecting areas, comprising the bonding materials of the heat activated adhesive tape, are not seams in the classical sense of the sewing techniques, as they do not comprise the perforations caused by needles, and they are relatively lightweight, strong, durable, and elastic, while not irritating the skin.

The invention will be further described and illustrated by the following examples.

### EXAMPLES

### Preparing a Heat Activated Adhesive Tape

Aliphatic polyether polyurethane (PEtPU), 95 g, and aliphatic polyester polyurethane (PEsPU), 4.9 g were loaded to a mixer and homogenized at ambient temperature for 5 minutes, followed by adding of 0.1 g polycarbodiimide based crosslinker, and homogenizing for 10 minutes, thereby obtaining a raw liquid latex.

The raw liquid latex was filled to a roll to roll slot die coating machine and layered on a release liner tape of MGK type, 50 cm wide. The material was dried by a highly efficient drying tunnel, flat drying tunnel with support rolls, to remove nearly all water. The coating velocity of 20-30 meters per minute provided a layer of 25 microns after drying, the coating velocity of 10-15 meters per minute provided a layer of 50 microns. The final jumbo roll was cutting the tape and rolling to small rolls in a dedicated slitter machine.

In one of the tests, the following raw materials were employed: Alberdingk U4101 for PEtPU, and Alberdingk U216 and/or U199 for PEsPU.

### Bonding and Testing

The adhesive tape was placed on a first fabric piece, the dry latex contacting the fabric and the liner upside. Pressure of about 5 bar was exerted (heat transfer press) for 5 seconds and by a metal plate heated to a temperature of 135° C. The liner was removed, and a second fabric piece was placed on the first one. A pressure of about 5 bar was exerted on both fabrics for 20 seconds, the temperature of the heat transferring press being 175° C.

The bonded fabrics samples were cut to 5-10 cm by 2.5 cm segments, and were monitored in a cell keeping 25° C. and 65% humidity for 72 hours. The adhesive strength was tested using Lloyd tensile test machine, according to ASTM-D 1876. 5 standard, and the found values of adhesion strength were 15-25 Newton for the 25 microns layer, and 20-45 Newton for 50 microns layer.

Adhesive's stability under the washing machine conditions was characterized in a standard washing machine at 60° C. and 1000 RMP, the washing machine being full to generate high shear forces. The adhesive stayed stable in 25 washing cycles.

After 25 cycles, the samples were dried in the cell at 25° C. and 65% humidity for 24 hours and then tested again by the Lloyd tensile test machine, according to ASTM-D 1876. 5 standard, finding the adhesion strength of 16-28 Newton for 24 microns layer, and 22-51 Newton for 50 microns layer.

Adhesive relaxation and flexibility were tested by Lloyd tensile machine according to the internal standard.

While the invention has been described using some specific examples, many modifications and variations are possible. It is therefore understood that the invention is not intended to be limited in any way, other than by the scope of the appended claims.

1. A heat activated adhesive tape for stitchless joining fabric sections, the tape comprising a thermostable liner, and a layer of dry latex of polyurethane with a crosslinker selected from the group consisting of polycarbodiimides, melamine formaldehydes, epoxies, and aziridines.

2. The tape of claim 1, wherein said latex comprises 95-99.9% aliphatic polyurethanes and 0.05-1% crosslinker.

3. The tape of claim 1, wherein said polyurethanes comprise polyether polyurethanes and polyester polyurethanes.

4. The tape of claim 1, comprising up to 5% additives.

5. The tape of claim 1, wherein said liner comprises a paper or polymer film, and said latex which coats the liner forms a layer of a thickness of from 5 to 500 μm.

6. The tape of claim 5, wherein said layer has a thickness of from 10 to 250 μm.

7. The tape of claim 5, wherein said layer has a thickness of from 20 to 125 μm.

8. The tape of claim 1, wherein said latex is released from said liner to a first fabric section when the section is pressed against the latex at a releasing temperature of 110° C. or more.

9. The tape of claim 8, wherein said releasing temperature is between 130 and 140° C.

10. The tape of claim 8, wherein said latex bonds said first fabric section to a second fabric section when said first section is pressed against said second section at a bonding temperature of 165° C. or more.

11. The tape of claim 10, wherein said bonding temperature is between 170 and 180° C.

12. A fabric article such as a garment comprising at least two fabric segments joined by a heat activated tape according to claim 1.

13. A method of manufacturing a heat activated adhesive tape for stitchless joining of fabric sections, comprising steps of
(i) providing an aqueous dispersion of aliphatic polyurethanes, and a crosslinker selected from the group consisting of polycarbodiimides, melamine formaldehydes, epoxies, and aziridines;
(ii) homogenizing said polyurethanes and said crosslinker at ambient temperature, to obtain a raw liquid latex;
(iii) layering said raw liquid latex onto the surface of a thermostable liner;
(iv) drying said liner with said raw latex in a high-efficient drying tunnel at a temperature lower than 100° C., thereby obtaining a liner film coated with a layer of dry latex;
(v) cooling said film with said dry latex; and
(vi) cutting the film with said dry latex to obtain bands of said adhesive tape of a desired width and length, and folding the bands to obtain rolls of said tape, or folding the film of a desired length to a film roll and cutting the film roll at a desired width to obtain rolls of said tape;
thereby obtaining rolls of said heat activated adhesive tape for stitchless joining fabric sections, stable at storage and ready for future use.

14. The method of claim 13, wherein said dispersion of aliphatic polyurethanes comprises 30-65% polyether polyurethanes in water, said crosslinker is added in an aqueous mixture, and comprising adding one or more additives selected from the group consisting of dispersants, surfactants, antifoams, fillers, stabilizers, preservatives, flexibility enhancers, plasticizers, and dyes.

15. The method of claim 13, wherein said layer of the dry latex has a thickness of from 20 to 125 μm.

16. The method of claim 13, wherein said polyurethanes, crosslinkers and additives are added in said raw liquid latex in amounts providing a dry latex containing 95-99.9% aliphatic polyurethanes, 0.05-1% polycarbodiimide crosslinker, and up to 5% additives.

17. A method of joining two fabric sections in a stitchless way, comprising steps of
(i) placing a heat activated adhesive tape comprising a thermostable liner, and a layer of dry latex of polyurethane with a polycarbodiimide crosslinker on a first fabric section with the latex facing the fabric and the liner upside, and pressing the tape against said fabric at a releasing temperature of 110° C. or more, at a pressure of 2 bars or more for a time of 2 s or more, thereby releasing said latex onto the surface of said first fabric section and defining a bonding area;
(ii) removing the liner from said bonding area;
(iii) placing a second fabric section on said first fabric section at said bonding area and pressing the two fabric sections to each other at said bonding area at a bonding temperature of 165° C. or more, at a pressure of 2 bars or more for a time of 5 s or more;
thereby bonding said two fabric sections in a stitchless way at said bonding area, wherein said bonding is stable during repeated laundry.

18. The tape of claim 1, comprising a polycarbodiimide crosslinker.
